(19) United States
(12) Patent Application Publication
(10) Pub. No.: US 2004/0143726 A1
(43) Pub. Date: Jul. 22, 2004

(54) Device comprising a microcontroller and modules for achieving a state machine

(76) Inventor: Horst Diewald, Freising (DE)

Correspondence Address: TEXAS INSTRUMENTS INCORPORATED, P O BOX 655474, M/S 3999, DALLAS, TX, 75265

(21) Appl. No.: 10/736,964

(22) Filed: Dec. 16, 2003

(30) Foreign Application Priority Data
Dec. 18, 2002 (DE) 102 59 282.9

(51) Int. Cl. G06F 15/00

(52) U.S. Cl. 712/36

(57) ABSTRACT

A microcontroller including a memory 10 and further electronic components configured capable of functioning as parts of a state machine 14, and an addressing circuit 20, a state register 25 and a data transfer circuit 22. The input of the addressing circuit 20 forms the input of the state machine 14, the output of the state register 25 forms the output of the state machine 14. The data transfer circuit 22 is connected to the addressing circuit 20, memory 10 and state register 25 in thus enabling the memory 10 of the microcontroller to be made use of for efficiently memorizing the changing state of the state machine.

### RELATED APPLICATION

The present application is based on priority of German Patent Application No. 102 59 282.9, filed on Dec. 18, 2002.

### FIELD OF THE INVENTION

The invention relates to a device including a microcontroller and modules for achieving a state machine.

### BACKGROUND OF THE INVENTION

Microcontrollers are used in many devices for sensing and processing measurement data, one example of which are electronic meters employing microcontrollers to process the signals of a sensor serving to sense a quantity defining consumption. The sensor may consist of a flow converter, a current/voltage bridge or a magneto-resistive assembly. The sensor signals are received by the microcontroller, converted into digital measurement data and further processed into physical measured quantities. For this purpose, instructions are memorized in the PROM of the microcontroller configured so that the microcontroller is able to meet these tasks. Any change needed in the program sequence is normally achievable by adapting the instructions in the PROM so that this device is flexible to changes as may occur, for example, when a new sensor type is used or when individual characters of the sensors need to be taken into account.

For controlling the sensor, several control signals are normally required. These control signals are used to control the signal output of the sensor or the signal conversion of the analog sensor signals by means of an analog/digital converter. These control tasks are relatively uncomplicated and are triggered by external or internal signals and necessitate a precise time sequence. So as to relieve the processing capacities of the microcontroller for handling these simple control tasks, electronic modules are often used independent of the microcontroller which satisfy the function of a state machine. This state machine works independently of the microcontroller and furnishes, for example, the signals as needed for controlling the signal output of the sensor.

In a state machine specific, states cycle as predefined in a so-called state diagram, the requirements for changing from one state to another are given by internal or external signals. As a hardware item, for example, a state machine is achievable by a memory module including a truth table saved therein to which the input vector is applied as the address and which furnishes at the output the corresponding new state as the output vector. A circuit working according to this principle is described, for example, in the German Semiconductor Circuit Textbook by U. Tietze and Ch. Schenk, published by Springer-Verlag, 12ₜₕ 10 edition, on pages 699 to 706.

The length of the input vector is defined on state machines achieved by a memory module, the size of the address space which the memory module needs to feature. In a device including a microcontroller and a state machine independent thereof as a hardware item, this address space of the state machine needs to be precisely defined already in the development phase to permit achieving the state diagram in a memory module selected sufficiently large. This makes the device less flexible to any later changes, however.

### SUMMARY OF THE INVENTION

The invention is thus based on the objective of achieving a device which is flexible as regards changed requirements on the state machine and in addition to this is simple and cost-effective to produce.

This objective is achieved in accordance with the invention by a device including a microcontroller including a memory and further electronic modules configured so that they function as parts of a state machine and include an addressing means, state register and data transfer means, the input of the addressing means forming the input of the state machine, the output of the state register forming the output of the state machine and the data transfer means being connected to the addressing means, the memory and the state register.

The device in accordance with the invention features a particularly simple configuration resulting from the dual function of the memory included in any case in every microcontroller for the instructions of the microcontroller and as a memory for the truth table of the state machine. This enables the state machine to work without a dedicated memory module. The addressing means and the data transfer means in this arrangement are configured so that various state diagrams can be adapted to the size of the PROM.

### BRIEF DESCRIPTION OF THE DRAWINGS

The invention will now be detailed by way of example with reference to the drawing in which:

FIG. 1 is a block diagram of one embodiment of the device in accordance with the invention.

### DETAILED DESCRIPTION OF THE DRAWINGS

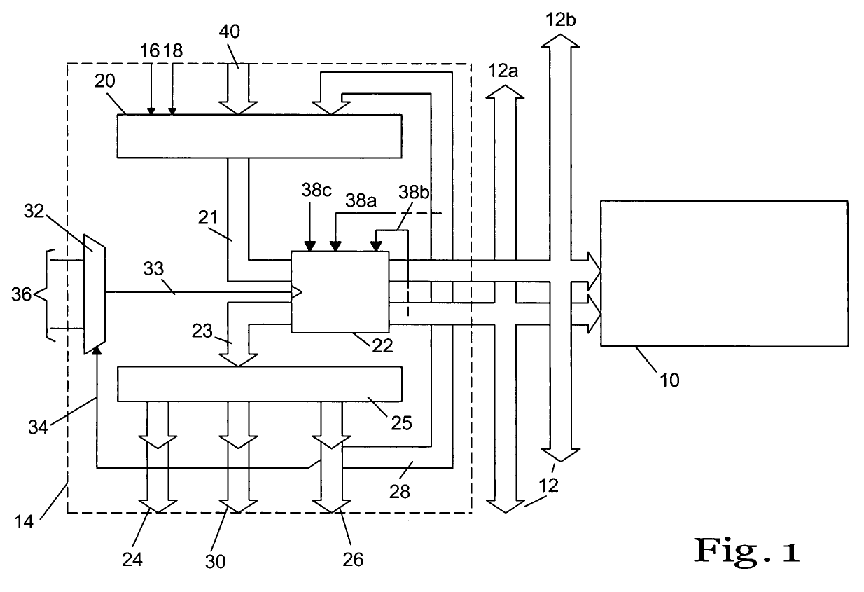

Referring now to FIG. 1, there is illustrated a block diagram of one embodiment of the device in accordance with the invention. The device includes a microcontroller not shown in detail in FIG. 1, including a PROM 10 and connected to a bus system 12. Since the precise structure of the microcontroller is irrelevant to the invention, only the PROM 10 of the microcontroller is shown in FIG. 1 to make for a better overview. The further components important to the function of the microcontroller e.g. a processor, additional circuits as may be required, such as e.g. a timer module, or input/output interfaces are known from prior art.

The device includes in addition a state machine 14 which as a function of input signals 16 generated external to the device or internal signals 18 originating for example from a microcontroller, cycles a predefined sequence of states. The input signals 16 and the internal signals 18 are termed control variables since by means of these signals the change from one state to another is prompted.

When the device in accordance with the invention is used, for example, to control the signal output of a sensor, the control variables can be generated e.g. by a switch with which a user can signal the device to read out the sensor. The control variables may also be furnished e.g. from a timer module, however, to start read out of the sensor, for example, at specific points in time. Likewise, the control variables may be the result of a calculation made by the microcontroller to control read out of the sensor by the microcontroller.

The inputs for the control variables are connected to an addressing means 20. The addressing means 20 generates at its output an address assigned to the input vector and communicates this address via address signal lines 21 to a data transfer means 22 which is connected to the bus system 12 of the microcontroller.

It is usually so that the bus system 12 is divided into a data bus 12a and an address bus 12b, although, of course, any other configuration may be provided, e.g. for communicating the addresses and data multiplexed. In the first case, the data transfer means 22 communicates the address furnished by the addressing means 20 via the address bus 12b to the address ports of the PROM 10. In the second case, the data transfer means 22 needs to be configured so that it can execute the corresponding protocol of a multiplex transfer.

The main task of the data transfer means 22 is to read the data value stored in the PROM 10 under the address furnished by the addressing means 20, i.e. so that reading out the PROM follows automatically without control (e.g. by corresponding software) by means of the microcontroller.

The data value represents the output vector of the state machine. In certain applications, the bit length of the data value may exceed the width of the data bus 12a. In this case, the data value needs to be saved in a plurality of memory locations of the ROM, the addressing means 20 being configured so that it generates all addresses required. This enables the data transfer means 22 to read all corresponding data values one after the other.

Via the data signal lines 23, the data transfer means 22 communicates the data value to a state register 25 in which for each element of the output vector, a memory location is provided. At some outputs of the state register 25, the control signals 24 are output as may be required, for example, for controlling the output of the sensor data, in that the other outputs 26 of the state machine control signals can be communicated to the inputs of the addressing means 20 via a connection 28.

It is this signal feedback via the outputs 26 that permits achieving a state machine 14 whose new state is derivable not only from the control variables (input signals 16, 18) but also from the momentary state of the state machine 14. This is often needed in the conversion of more complex state diagrams since the new states in general are described by a function which depends not only on the control variables but also on the value of the state at the time.

Still further, outputs 30 of the state register 25 may also be provided. At these further outputs 30, so-called concealed state variables are generated needed for a defined description of states having no difference in the values of the control signals and in the values of the feedback signals as may be involved, for example, in waiting states or states describing the counts of a loop counter retrieved successively.

The following shows some special aspects of the device in accordance with the invention in which optimizing the data transfer with the PROM 10 is of importance.

The data transfer means 22 can be controlled by a control circuit 32 including a multiplexer and a signal 33 for controlling the transfer of addresses and data of the PROM 10. For this purpose, a signal may be used, for example, which is derived from one of the control inputs 36. Selecting one of the control inputs 36 at which various clock signals may be available, and can be controlled by a signal 34 derived, for example, from one or more outputs 26 of the state register 25. This permits achieving control of the data transfer means 22 as a function of the state as stored in the state register 25 at the time as necessary, for example, when during processing of specific states another timing response of the data transfer means 22 is desired.

In addition, the data transfer means 22 may be controlled by control signals 38 serving to adapt operation of the data transfer means 22 as a function of the momentary state 38a, a value 38b of the input vector or of a further input signal 38c in thus enabling the device in accordance with the invention to implement an optimized working routine which is either related to the momentary state as regards the signals 38a or 38b or as a function of the input signal 38c.

It is also possible to support state variables with a differing plurality of elements as resulting e.g. for differing tasks or materializing during processing of subordinate state diagrams. So that a correct address can be applied to the PROM for the various dimensions of the input and output vector, the address needs to be widened to comply with the width of the address bus 12b. This task can be handled by the addressing means 20. The addressing means 20 can also be supplied with a signal 40 furnished from a register (not shown in FIG. 1) in making a base address available. This enables the destination address in the PROM to be shifted to thus achieve simple means of adapting to the memory location of the PROM 10 available at the time.

The addressing means 20 and the state register 25 may in addition including a FIFO memory for caching the address or data values in thus permitting 20 decoupling operation of the microcontroller from that of the state machine. Similar to a cache of a processor, the FIFO memory provides temporary buffering of the values held therein until needed by the state register 25 or addressing means 20.

The processing speed of the state machine can be controlled in many different ways. In addition to a fixed clock signal, for example, an output of a timer module of the microcontroller can be used as can be varied by means of suitable instructions held in the PROM 10.

The device in accordance with the invention is compatible with a variety of different memory types and memory technologies. Thus, e.g. the PROM 10 for prototypes in the case of device may consist of a flash memory, the content of which can be varied by simple ways and means; whereas for mass production of the device in accordance with the invention a low-cost ROM can be used, for example; although it is just as possible to use an EPROM, EEPROM, RAM or ferro RAM as the PROM 10.

The device in accordance with the invention comprising a microcontroller and a state machine 14 working independently of the microcontroller permits flexible adaptation to a variety of state diagrams in thus permitting modifications to be simply implemented highly effectively. By making use of the PROM 10, including in any case in the microcontroller, signaled by means of the addressing means 20 and the data transfer means 22 and containing a truth table for the state machine 14, input and output vectors of the state machine differing in size are now achievable. In addition, making use of the PROM 10 is highly cost-effective since otherwise when using an independent memory for the state machine, no further components need to be provided for integrating the memory in the device. This also results in energy being saved in the device in accordance with the invention as is very important when the device in accordance with the invention is put to use, for example, in battery-powered appliances required to have a low current consumption.

The device in accordance with the invention is particularly suitable for application in meters as aforementioned in which the electronic components capable of functioning as parts of a state machine, are circuited between the sensor and the memory of the microcontroller serving to process and analyze the sensor signals.

1. A device including a microcontroller comprising:
a memory (10),
a state machine (14),
an addressing means (20),
a state register (25), and
a data transfer means (22), wherein the input of said addressing means (20) forms the input of said state machine (14), the output of said state register (25) forms the output of said state machine (14) and said data transfer means (22) is connected to said addressing means (20), memory (10) and state register (25).

2. The device as set forth in claim 1 wherein said addressing means (20) is configured of forming from the input signals applied to said state machine (14), defining said input vector of said state machine (14), addresses under which in said memory (10) of said microcontroller data are held which define the output vector of said state machine (14).

3. The device as set forth in claim 1 wherein said data transfer means (22) is in addition configured capable of accepting the address furnished by said addressing means (20) and relaying it to said memory (10) and receiving data values held in said memory (10) under said address and communicating them to said state register (25).

4. The device as set forth in claim 1 wherein said addressing means (20) comprises a further input and said state register (25) comprises a further output (26) which is connected via an connection (28) to said further input of said addressing means (20).

5. The device as set forth in claim 1 wherein, in addition, a control circuit (32) is provided for controlling said data transfer means (22).

6. The device as set forth in claim 5 wherein said control circuit (32) is configured controllable by one or more output signals of said state register (25).

7. The device as set forth in claim 1 wherein said memory (10) is a flash memory, EPROM, EEPROM, ROM, RAM or ferro RAM.

8. The device as set forth in claim 1 wherein said memory (10) is the PROM of said microcontroller.

9. The device as set forth in claim 1 wherein, in addition, a FIFO memory is provided, circuited between said addressing means (20) and said data transfer means (22) and serves to cache the addresses generated by said addressing means (20).

10. The device as set forth in claim 1 wherein, in addition, a FIFO memory is provided, circuited between said data transfer means (22) and said state register (25) and serves to cache said data communicated by said data transfer means (22).

11. A meter including a device as set forth in claim 1.

12. The meter as set forth in claim 11 wherein the state machine is arranged between a sensor of said meter, serving to sense a quantity representing the consumption, and said memory of said microcontroller serving to process and analyze said sensor signals and to establish consumption.
